(19) United States
(12) Patent Application Publication
(10) Pub. No.: US 2008/0166537 A1
(43) Pub. Date: Jul. 10, 2008

(54) Coaxial Cable With Foamed Insulation

(75) Inventors: David J. Frankowski, Raleigh, NC (US); Rodney E. Ginger, Beaconsfield (CA); Sandra Maki, Beaconsfield (CA); Scott H. Wasserman, Morganville, NJ (US)

Correspondence Address: The Dow Chemical Company, Intellectual Property Section, P.O. Box 1967, Midland, MI, 48641-1967, US

(73) Assignee: Dow Global Technologies Inc., Midland, MI (US)

(21) Appl. No.: 11/596,912

(22) PCT Filed: May 24, 2005
(86) PCT No.: PCT/US2005/018017

§ 371 Date: Nov. 17, 2006

Related U.S. Application Data
(60) Provisional application No. 60/574,678, filed on May 26, 2004.

(51) Int. Cl. B32B 5/18

(52) U.S. Cl. 428/304.4

(57) ABSTRACT

The present invention is directed to a coaxial cable comprising (a) an inner conductor, (b) an outer conductor, and (c) a foamed insulation, surrounding the inner conductor. The foamed insulation is prepared from an insulation composition comprising a foamable polymer, a foaming agent, and a particulate, non-halogenated, nonheterocyclic polyolefinic nucleating agent. The invention is also related to methods and compositions for making the foamed insulation.

The present invention relates to coaxial cables. In particular, the invention relates to foamed insulation useful in coaxial cables as well as methods and compositions for making the foamed insulation.

### BACKGROUND OF THE INVENTION

Coaxial cables are used extensively in the communications industry. The coaxial cables generally include an inner conductor, an outer conductor, and a foamed insulation layer. Other components may include an inner skin and an outer skin adjacent to the insulation, and a jacket forming a sheath around the outside of the coaxial cable.

The composition for preparing the foamed insulation layer generally comprises a low polarity organic foamable polymer, a foaming (or blowing) agent, and a nucleating agent. The composition is extruded over the inner conductor to form the foamed insulation layer. The insulation layer is foamed to decrease its dielectric constant (DC).

Foaming agents include chemical and physical foaming agents. The foaming agents may be used individually or in combination.

Examples of chemical foaming agents are azodicarbonamide (ADCA), azobisisobuty-ronitrile (AIBN), N,N′-dinitrosopenta-methylenetetramine (DPT), p-toluenesulfonylhydrazid (TSH), 4,4′-oxybis-benzenesulfonylhydrazide (OBSH), sodium bicarbonate, and ammonium carbonate. For example, extrusion temperatures decompose OBSH and ADCA. The decomposition of the foaming agent results in uniform foaming.

Unfortunately, the decomposition of chemical foaming agents, such as OBSH and ADCA, produces water and other decomposition products that degrade the electrical properties of the insulating foam layer.

Physical foaming agents include gases such as nitrogen, carbon dioxide, chlorinated fluorocarbons, freons, helium, neon, argon, krypton, xenon, and radon. Unfortunately, gases may not provide uniform foaming which can result in large cell sizes and unsatisfactory cell size distribution. Also, chlorinated fluorocarbons gases may be harmful to the environment.

Nucleating agents include such materials as diatomaceous earth, silica, boron nitride, ZnO₂, and MgO. These nucleating agents are used to enhance the cell structure of foaming polymers. However, while boron nitride can provide acceptable electrical properties, its use can be cost prohibitive.

Chemical blowing agents, such as ADCA, have been used as nucleating agents. For physical foaming, the composition must be processed at low temperatures so as to avoid decomposing these nucleating agents. These temperature requirements can limit the manufacturing rates for coaxial cables.

Fluororesin powders have also been used as nucleating agents. Examples include polytetrafluoroethylene (PTFE), tetrafluoroethylene-perfluoroethylenehexa-fluoropropylene copolymer (FEP), tetrafluoroethylene-ethylene copolymer, polyvinylidene fluoride (PvdF), polychlorotrifluoroethylene (PCTFE), and chloro-trifluoroethylene-ethylene copolymer (ECTFE). These fluororesin powders are expensive and provide limited electrical properties.

It is desirable to provide a coaxial cable having low signal losses at elevated frequencies. Specifically, it is desirable to provide a coaxial cable insulation having a low dissipation factor and a low dielectric constant. It is further desirable to provide a composition for preparing a foamed insulation layer, wherein the composition has sufficiently high expansion rates to render the composition useful for commercial applications.

### SUMMARY

The present invention is directed to a coaxial cable comprising (a) an inner conductor, (b) an outer conductor, and (c) a foamed insulation, surrounding the inner conductor. The foamed insulation is prepared from an insulation composition comprising a foamable polymer, a foaming agent, and a particulate, non-halogenated, non-heterocyclic polyolefinic nucleating agent.

The particulate, non-halogenated, non-heterocyclic polyolefinic nucleating agent has a particle size and a surface tension which are effective for foaming the foamable polymer at an expansion rate of at least about 70 percent. Preferably, the nucleating agent also has a melting point of at least about 15 degrees Celsius higher than the melting point of the foamable polyolefin.

### DETAILED DESCRIPTION

In a first embodiment, the present invention is a coaxial cable comprising (a) an inner conductor, (b) an outer conductor, and (c) a foamed insulation, surrounding the inner conductor. In particular, the foamed insulation is prepared from an insulation composition comprising (i) a foamable polymer, (ii) a foaming agent, and (iii) a particulate, non-halogenated, non-heterocyclic polyolefinic nucleating agent.

The inner conductor and the outer conductor can be prepared from any conductive material suitable for transmitting a communication signal. Commonly used conductors include conductors made with copper and aluminum.

Examples of foamable polymers suitable for use in the present invention include polyolefins, thermoplastic resins, rubbers, thermoplastic elastomers, polyamide, polyacetal, thermoplastic polyester, polycarbonate, polyphenyleneoxide, polyphenylene ether, polysulfone, poly (amide imide), poly (ether imide), poly (ether sulfone), and poly (ether ketone).

Suitable polyolefins include polyethylene, polypropylene, and polybutene.

Suitable thermoplastic resins include polystyrene, poly vinyl chloride, poly vinylidene chloride, ethylene-vinyl acetate copolymer, and ethylene-ethyl acrylate copolymer.

Suitable rubbers include natural rubber, isoprene rubber, butyl rubber, ethylene-propylene copolymer rubber, ethylene-propylene-diene terpolymer rubber, styrene-butadiene copolymer rubber, acrylonitrile-butadiene copolymer rubber, ethylene-vinyl acetate copolymer rubber, ethylene-ethyl acrylate copolymer rubber, chlorosulfonated polyethylene rubber, epichlorohydrine rubber, silicone rubber, and fluoro rubber.

Suitable thermoplastic elastomers include styrene thermoplastic elastomers, polyolefin thermoplastic elastomers, poly(vinyl chloride) thermoplastic elastomers, polyurethane thermoplastic elastomers, and polyester thermoplastic elastomers.

Suitable styrene thermoplastic elastomers include ABA triblock elastomers and (AB) n X type radial block elastomers. Suitable polyolefin thermoplastic elastomers include blend type TPO, partially crosslinked blend type TPO, and complete crosslinked blend type TPO. Suitable poly(vinyl chloride) thermoplastic elastomers include elastomer blended with nitrile rubber and elastomer blended with partially crosslinked nitrile rubber. Suitable polyurethane thermoplastic elastomers include polyester-polyurethane elastomer, and polyether-polyurethane elastomer. Suitable polyester thermoplastic elastomers include polyester-polyether elastomer, and polyester-polyester elastomer.

These polymers generally are supplied in the form of pellets of generally spherical or cylindrical shape and 1-3 millimeters in length or diameter that are heated and extruded. The pellets may contain common binding agents, antioxidants, or other additives commonly used in the field.

The foaming agent should be suitable for the extrusion temperature, foaming conditions, and the foaming method. The foaming agent can be a physical foaming agent or a chemical foaming agent. When the foamed insulation is foamed simultaneously with extrusion forming, a physical foaming agent is preferably used.

Examples of physical foaming agents suitable for use with the present invention include non-reactive gases and inert gases. Such gases include nitrogen, freons, carbon dioxide, hydrocarbons, helium, neon, argon, krypton, xenon, and radon. Suitable hydrocarbons include non-halogenated hydrocarbons such as methane, propane, butane, and pentane, and halogenated hydrocarbons such as dichlorodifluoromethane, dichloromonofluoromethane, monochlorodifluoromethane, trichloromonofluoromethane, monochloropentafluoroethane, and trichlorotrifluoroethane.

Chemical foaming agents useful with the present invention include those foaming agents which decompose to form a gas.

The amount of the foaming agent is generally added to insulation composition in an amount from 0.001 to 0.1 parts by weight per hundred parts by weight of the foamable polymer. Preferably, the foaming agent is added in an amount from 0.005 to 0.05 parts by weight per hundred parts by weight of the foamable polymer.

The foaming agent may be mixed with the foamable polymer prior to or simultaneously with the extrusion of the insulation composition.

The particulate, non-halogenated, non-heterocyclic polyolefinic nucleating agent of the present invention does not decompose at the processing or foaming temperatures and is chemically inactive in the foaming process.

The nucleating agent has a particle size, which is effective for foaming the foamable polymer. Generally, the nucleating agent has (1) an average particle size from 0.1 to 100 μm and (2) 50 percent or more of the particles by number having a particle size in the range of 0.1 to 0.5 μm.

Generally, the nucleating agent has a surface tension less than about 30 dynes/cm. Preferably, its surface tension will be less than about 20 dynes/cm.

When dispersed in the melted foamable polymer and because of its small particle size and surface tension, the nucleating agent effectively provides nucleating sites for gas bubbles so that the foamable polymer will have an expansion rate of at least about 70 percent. Preferably, the expansion rate will be greater than about 80 percent.

To achieve an expansion rate of at least about 70 percent, the nucleating agent is generally used in an amount from 0.01 to 1.0 weight percent based on the total weight of the insulation composition. Preferably, the nucleating agent is used in an amount from 0.02 to 0.2 weight percent.

The nucleating agent also has a differential scanning calorimetry (DSC) melting point of at least 130 degrees Celsius. Preferably, the DSC melting point of the nucleating agent is in the range from 130 degrees Celsius to 240 degrees Celsius.

Also, preferably, the melting point of the nucleating agent is at least 15 degrees Celsius above the melting point of the foamable polymer. More preferably, nucleating agent's melting point is at least 25 degrees Celsius above the melting point of the foamable polymer.

As used herein, a halogen is defined according to the Periodic Table to include fluorine, chlorine, bromine, iodine, and astatine. Based upon that definition and as used herein, “non-halogenated” means the nucleating agent does not have more than trace amounts of fluorine, chlorine, bromine, iodine, or astatine.

As used herein, “non-heterocyclic” means the nucleating agent does not have more than trace amounts of heterocyclic chemical structures.

In an important aspect, the nucleating agent is a polyolefin having alkyl branching where the alkyl branches have greater than 3 carbon atoms, generally 3 to 12 carbon atoms, preferably non-linear alkyl branching where the alkyl branches have greater than 3 carbon atoms. In another important aspect, the monomer to make the nucleating agent is terminated such that the penultimate carbon at the end of the monomer opposite its double bond has an alkyl substitution. In another aspect, the alkyl substitution on the olefin monomer is a lower alkyl having 1 to 4 carbons.

Examples of the nucleating agents include poly 4-methylpentene-1, poly 4-methylhexene-1, poly 5-methylhexene-1, poly 4-methylheptene-1, poly 5-methylheptene-1, poly 6-methylheptene-1, polymers of similarly mono-alkyl-substituted linear alkenyl monomers of longer than 7 carbons, polymers of multiply-alkyl-substituted linear alkenyl monomers of 5 or greater carbon atoms, polymers of mono-alkyl-substituted or multiply-alkyl-substituted linear alkenyl monomers in which the substituents area are at least 1 carbon in length, and mixtures thereof. Preferably, the alkyl branches of the linear alkenyl monomer have 1 to 12 carbon atoms.

In another embodiment of the present invention, a method for making a foamed insulation is provided. The foamable polymer is blended with the nucleating agent and extruded with a gas or gas-forming foaming agent to provide the foamed insulation. More specifically, the foaming can preferentially occur by extruding the blend by a conventional method in the presence of the foaming agent from under a high pressure to a lower pressure.

In another embodiment of the present invention, a coaxial cable comprising a foamed insulation layer having a low dissipation factor and a low dielectric constant is provided. Also, preferably, a melt blend used to make the foamed insulation layer will have a dissipation factor less than that which is achievable in a comparable melt blend prepared with azodicarbonamide or polytetrafluoroethylene. Also, preferably, the melt blend used to make the foamed insulation layer will have a dielectric constant less than or equal to that which is achievable in a comparable melt blend prepared with azodicarbonamide or polytetrafluoroethylene.

### EXAMPLES

The following examples are illustrative of, but not limiting upon, the scope of the invention which is defined in the appended claims.

### Example 1 and Comparative Examples 2 and 3

Three melt blends were prepared with about 10 percent by weight of three nucleating agents in a low density polyethylene (LDPE), having a melt index of 1.8 grams per 10 minutes (ASTM 1238, condition I) and a density of 0.919 grams per cubic centimeter (ASTM D-792). Irganox MD 1024™ 1,2-bis(3,5-di-tert-butyl-4-hydroxyhydrocinnamoyl)-hydrazine, as an antioxidant, was added to the melt blends.

The nucleating agent poly 4-methylpentene-1 (Poly 4-MP-1), when used, was obtained as TPX 820M from Mitsui Chemical. The nucleating agent polytetrafluoroethylene (PTFE), when used, was obtained as Zonyl MF-1400 from DuPont. The nucleating agent azodicarbonamide (ADCA), when used, was obtained as Celogen AZ 130 from Crompton Corporation.

At 1 MHz, the dielectric properties were measured using a Q-Meter apparatus originally available commercially from Boonton Radio Company, now a Division of Hewlett-Packard. At 2.4 GHz, the dielectric properties were measured using a split-post dielectric resonator.

Table I recites the results of those tests.

TABLE 1

| Component | Example 1 | Comp. Example 2 | Comp. Example 3 |
|---|---|---|---|
| LDPE | 89.8 | 88.5 | 88.5 |
| Nucleating Agent | Poly 4-MP-1 | PTFE | ADCA |
| Irganox MD 1024 | 0.2 | 1.5 | 1.5 |

Test at 1 MHz

| | | |
|---|---|---|
| Dielectric Constant | 2.28 | 2.35 |
| Dissipation Factor | 8.00 × 10⁻⁵ | 4.00 × 10⁻⁵ |
| (radians) | | |

Test at 2.4 GHz

| | | | |
|---|---|---|---|
| Dielectric Constant | 2.28 | 2.30 | 2.38 |
| Dissipation Factor | 2.67 × 10⁻⁴ | 5.32 × 10⁻⁴ | 4.00 × 10⁻⁴ |
| (radians) | | | |

### Examples 4 and 5 and Comparative Examples 6-8

Examples 4 and 5 and comparative examples 6-8 were evaluated for capacitance stability, expansion rate, and surface quality.

Each evaluated material was prepared with (1) DGDA-6944 NT high density polyethylene, commercially available from The Dow Chemical Company and having a melt index of 8 grams per 10 minutes, a density of 0.965 grams per cubic centimeter, and a melting point between 135 to 138 degrees Celsius; (2) DFDA-1253 NT low density polyethylene, commercially available from The Dow Chemical Company and having a melt index of 1.8 grams per 10 minutes, a density of 0.919 grams per cubic centimeter, and a melting point of 110 degrees Celsius; and (3) Irganox MD 1024™ 1,2-bis(3,5-di-tert-butyl-4-hydroxyhydrocinnamoyl)-hydrazine. Three of the evaluated materials also include the component DYNH-1 low density polyethylene, commercially available from The Dow Chemical Company and having a melt index of 2.1 grams per 10 minutes, a density of 0.919 grams per cubic centimeter, and a melting point of 110 degrees Celsius.

The nucleating agent poly 4-methylpentene-1 (Poly 4-MP-1), when used, was obtained as TPX 820M from Mitsui Chemical. The nucleating agent polytetrafluoroethylene (PTFE), when used, was obtained as Zonyl MF-1400 from DuPont. The nucleating agent azodicarbonamide (ADCA), when used, was obtained as Celogen AZ 130 from Crompton Corporation.

Table II shows the formulations used to prepare the exemplified compositions and the results obtained for each composition. The formulations were extruded as RG-11 coaxial cable insulation using nitrogen as a physical foaming agent. The RG-11 coaxial cable includes a 14 AWG wire that is precoated with low density polyethylene (LDPE) or linear low density polyethylene (LLDPE) polymer (precoated layer wall thickness of 0.001 to 0.003 inches). The diameter fluctuations for the insulations were 0.013 inches.

The insulation layer is extruded onto the pre-coated wire from a main Royle extruder at a target outside diameter of 0.280 inches. Each composition was processed with 30-inch air gap.

Tables III and IV show the processing conditions for preparing the test specimens.

The cell structure of the insulation prepared according to the present invention had regular, closed-cells throughout the entire insulation. The poly 4-methylpentene-1 nucleating agent provided slightly larger cells (127 μm to 360 μm versus 64 μm to 191 μm) but this did not prevent the insulation from being foamed to the desired expansion level with a smooth outside surface.

TABLE II

| | Example 4 | Example 5 | Comp. Ex. 6 | Comp. Ex. 7 | Comp. Ex. 8 |
|---|---|---|---|---|---|
| Component | | | | | |
| DGDA-6944 NT HDPE | 70 | 70 | 70 | 70 | 70 |
| DFDA-1253 NT LDPE | 25 | 25 | 25 | 27 | 27 |
| Nucleating Agent Blend | 5 | 5 | 5 | 3 | 3 |

10 percent Nucleating Agent Blend Components

| | | | | | |
|---|---|---|---|---|---|
| DFDA-1253 NT LDPE | 89.8 | 89.8 | | | |
| DYNH-1 LDPE | | | 88.5 | 88.5 | 88.5 |
| Irganox MD-1024 | 0.2 | 0.2 | 1.5 | 1.5 | 1.5 |
| Nucleating agent | Poly 4-MP-1 | Poly 4-MP-1 | PTFE | PTFE | ADCA |
| | | (ground) | | | |

Properties

| | | | | | |
|---|---|---|---|---|---|
| Outside diameter (mils) | 282-295 | 285-298 | 282-295 | 295-305 | 290-300 |
| Capacitance stability | 14.0 ± 0.2 | 13.7 ± 0.15 | 14.1 ± 0.2 | 13.8 ± 0.1 | 13.95 ± 0.10 |
| (pF/ft) | | | | | |
| Expansion (percent) | 70.0 | 71.5 | 70.0 | 72.5 | 71.1 |
| Surface Quality | Smooth (—) | Very Smooth | Smooth (—) | Smooth | Smooth |
| Process Conditions | | | | | |

Royle Extruders

| | | | | | |
|---|---|---|---|---|---|
| RPM | 24.6 | 24.6 | 24.6 | 23.1 | 23.1 |
| Amps | 19 | 19 | 19 | 19 | 19 |
| Line Speed | 77 | 77 | 77 | 75 | 75 |
| Gum Space (turns) | 2 | 2 | 2 | 1.5 | 1.5 |
| Screen Pack | 20/60/40/20 | 20/60/40/20 | 20/60/40/20 | 20/60/40 | 20/60/40 |

Temperature Profile (degrees Celsius)

| | | | | | |
|---|---|---|---|---|---|
| Preheat | 120 | 120 | 120 | 65.5 | 65.5 |
| Zone 1 > Set/Actual | 155/155 | 155/153 | 155/153 | 150/149 | 145/144 |
| Zone 2 > Set/Actual | 175/176 | 175/176 | 175/174 | 175/176 | 165/166 |
| Zone 3 > Set/Actual | 190/190 | 190/190 | 190/190 | 190/190 | 185/185 |
| Zone 4 > Set/Actual | 185/185 | 185/185 | 185/185 | 185/185 | 180/180 |
| Zone 5 > Set/Actual | 180/180 | 180/180 | 180/180 | 180/180 | 175/175 |
| Die 1 > Set/Actual | 175/175 | 175/175 | 175/175 | 175/175 | 175/175 |
| Die 2 > Set/Actual | 174/175 | 175/175 | 175/175 | 175/175 | 175/175 |
| Cooling Trough | | 35/8/8 | 35/8/8 | 35/8/8 | 35/12/12 |
| Melting Temperature | 181 | 181 | 181 | 180 | 179 |

TABLE IV

| | | | | | |
|---|---|---|---|---|---|
| Process Conditions | Example 4 | Example 5 | Comp. Ex. 6 | Comp. Ex. 7 | Comp. Ex. 8 |

Pressures

| | | | | | |
|---|---|---|---|---|---|
| Zone 1 | <500 | <500 | <500 | <500 | <500 |
| Zone 2 | 1200-1400 | 1200-1400 | 1200-1400 | 1100-1300 | 1050-1250 |
| Injection Zone P1 | 3500 | 3500 | 3500 | 3400 | 3400 |
| Injection Zone P2 | 1425 | 1425 | 1450 | 1250 | 1300 |
| Zone 4 | 1900-2100 | 1800-2100 | 1800-2100 | 1500-1650 | 1700-1850 |
| Zone 5 (before breaker) | 2600 | 2550 | 2550 | 2000-2100 | 2300 |
| Die 1(before breaker) | 2350 | 2300 | 2250 | 1800 | 2050 |

Run time (minutes)

| | | | | |
|---|---|---|---|---|
| 30 | 29 | 21 | 29 | 29 |

What is claimed is:

1. A coaxial cable comprising:
(a) an inner conductor,
(b) an outer conductor, and
(c) a foamed insulation, surrounding the inner conductor, prepared from an insulation composition comprising
(i) a foamable polymer,
(ii) a foaming agent, and
(iii) a particulate, non-halogenated, non-heterocyclic polyolefinic nucleating agent having a particle size and a surface tension which are effective for foaming the foamable polyolefin polymer at an expansion rate of at least about 70 percent.

2. The coaxial cable of claim 1, wherein the nucleating agent is effective for providing an expansion rate of greater than about 80 percent.

3. The coaxial cable of claim 1, wherein the nucleating agent has an average particle size in the range from 0.1 μm to 100 μm.

4. The coaxial cable of claim 1, wherein the nucleating agent has a surface tension of less than about 30 dynes/cm.

5. The coaxial cable of claim 1, wherein the nucleating agent being added in an amount from 0.01 to 1.0 weight percent based on the weight of the insulation composition.

6. The coaxial cable of claim 1, wherein the nucleating agent has a melting point in the range between 130 degrees Celsius to 240 degrees Celsius.

7. The coaxial cable of claim 1, wherein the nucleating agent has a melting point at least 15 degrees Celsius higher than the melting point of the foamable polymer.

8. The coaxial cable of claim 1, wherein the nucleating agent is selected from the group consisting of poly 4-methylpentene-1, poly 4-methylhexene-1, poly 5-methylhexene-1, poly 4-methylheptene-1, poly 5-methylheptene-1, poly 6-methylheptene-1, and mixtures thereof.

9. An insulation composition comprising:
(a) a foamable polymer,
(b) a foaming agent, and
(c) a particulate, non-halogenated, non-heterocyclic polyolefinic nucleating agent having a particle size and a surface tension which are effective for foaming the foamable polyolefin polymer at an expansion rate of at least about 70 percent.

10. The insulation composition of claim 9, wherein the nucleating agent is effective for providing an expansion rate of greater than about 80 percent.

11. The insulation composition of claim 9, wherein the nucleating agent has an average particle size in the range from 0.1 μm to 100 μm.

12. The insulation composition of claim 9, wherein the nucleating agent has a surface tension of less than about 30 dynes/cm.

13. The insulation composition of claim 9, the nucleating agent being added in an amount from 0.01 to 1.0 weight percent based on the weight of the insulation composition.

14. The insulation composition of claim 9, wherein the nucleating agent has a melting point in the range between 130 degrees Celsius to 240 degrees Celsius.

15. The insulation composition of claim 9, wherein the nucleating agent has a melting point at least 15 degrees Celsius higher than the melting point of the foamable polymer.

16. The insulation composition of claim 9, wherein the nucleating agent is selected from the group consisting of poly 4-methylpentene-1, poly 4-methylhexene-1, poly 5-methylhexene-1, poly 4-methylheptene-1, poly 5-methylheptene-1, poly 6-methylheptene-1, and mixtures thereof.
